(19) United States
(12) Patent Application Publication
(10) Pub. No.: US 2002/0077942 A1
(43) Pub. Date: Jun. 20, 2002

(54) Method for auditing intellectual property

(76) Inventor: William T. Wilkinson, Salem, NJ (US)

Correspondence Address: RATNER & PRESTIA, P.O. BOX 7228, WILMINGTON, DE, 19803, US

(21) Appl. No.: 09/975,217

(22) Filed: Oct. 11, 2001

Related U.S. Application Data
(60) Provisional application No. 60/240,135, filed on Oct. 13, 2000.

(51) Int. Cl. G06F 17/60

(52) U.S. Cl. 705/30

(57) ABSTRACT

A method for auditing one or more intellectual property assets of an entity. The method comprises the steps of: identifying and classifying each intellectual property asset; inspecting documentation related to each intellectual property asset; determining validity of each intellectual property asset; identifying and verifying relevant financial data for each intellectual property asset; identifying and verifying a proper tangible valuation formula for each intellectual property asset; computing and verifying a tangible valuation for each intellectual property asset using the formula; preparing an income statement reflecting revenue and expenses associated with each intellectual property asset; preparing a balance sheet reflecting each intellectual property asset and corresponding valuation; and issuing an opinion certifying that the one or more intellectual property assets and corresponding tangible values are fairly stated in accordance with generally accepted accounting principles.

### CROSS-REFERENCE TO RELATED APPLICATIONS

This application claims priority of U.S. Provisional Application Serial No. 60/240,135, filed on Oct. 13, 2000, incorporated herein by reference.

### TECHNICAL FIELD

This invention relates to accounting for and valuation of intellectual property, and more particularly to a method for conducting an audit of the intellectual property of a business entity.

### BACKGROUND OF THE INVENTION

Increasingly, Intellectual Property (IP) assets are becoming more important and valuable to business. They are unique assets that have heretofore been classified as intangible, but are now being recognized as having a more tangible or real value. Organizations need to account very accurately for their IP assets, so that they can manage them better. Although IP due diligence evaluations are often performed pursuant to mergers and acquisitions, there is no generally accepted standard for reflecting the value of IP assets in the financial statements of business entities. Thus, there is a need for a specific audit method to identify and verify IP assets and their proper classification, and verify the values of one or more IP assets, for any purpose, but particularly for financial statement purposes.

### SUMMARY OF THE INVENTION

In accordance with this invention, there is provided a method for auditing one or more intellectual property assets of an entity. The method comprises the steps of:

(a) identifying and classifying each intellectual property asset;

(b) inspecting documentation related to each intellectual property asset;

(c) determining validity of each intellectual property asset;

(d) identifying and verifying relevant financial data for each intellectual property asset;

(e) identifying and verifying a proper tangible valuation formula for each intellectual property asset;

(f) computing and verifying a tangible valuation for each intellectual property asset using said formula;

(g) preparing an income statement reflecting revenue and expenses associated with each intellectual property asset;

(h) preparing a balance sheet reflecting each intellectual property asset and corresponding valuation; and

(i) issuing an opinion certifying that the one or more intellectual property assets and corresponding tangible values are fairly stated in accordance with generally accepted accounting principles.

As used above “each” intellectual property asset refers to each IP asset being audited. The audit may be performed on one or more assets, which may comprise 100% of the IP assets of an entity, a representative sampling of the IP assets of the entity, or merely a singular asset of the entity.

### BRIEF DESCRIPTION OF DRAWINGS

FIG. 1 is a flowchart of an exemplary method of the present invention.

### DESCRIPTION OF INVENTION

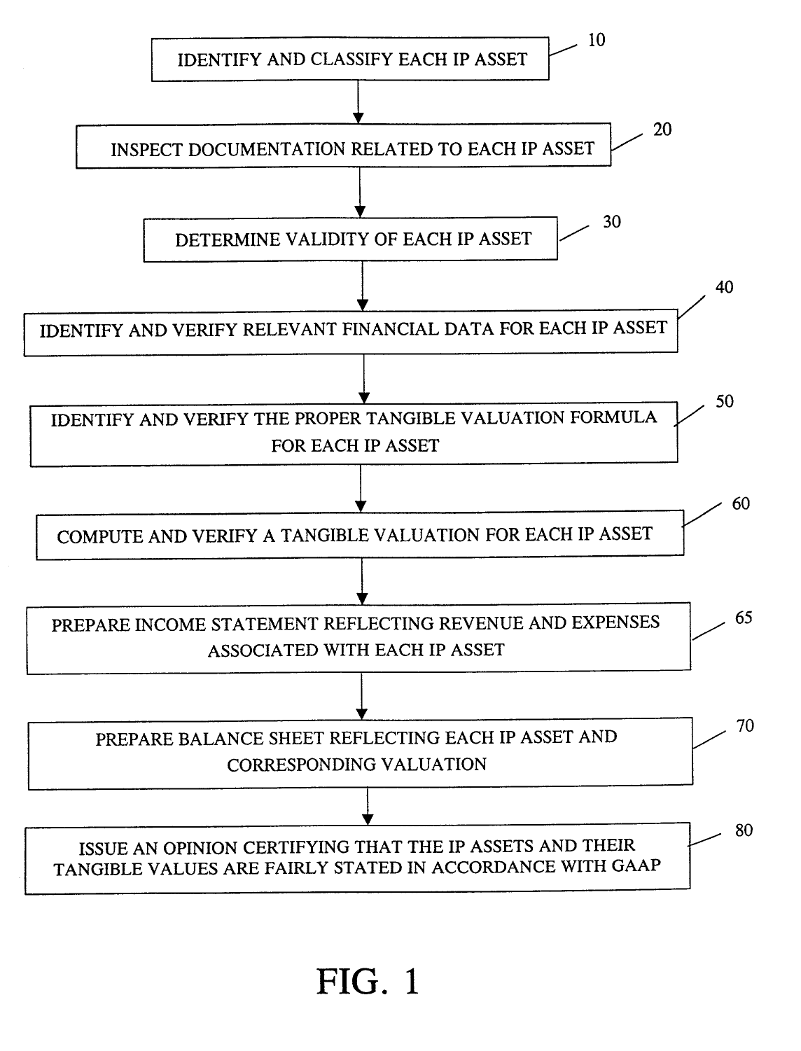

The invention will next be illustrated with reference to the figure. The figure is intended to be illustrative rather than limiting and is included herewith to facilitate the explanation of the method of this invention. Referring now to FIG. 1, there is shown a flowchart depicting the steps of an exemplary method according to this invention for auditing one or more IP assets of an entity.

As shown in step 10, the method first comprises identifying and classifying each IP asset. This step includes, for example, determining the type, subtype, and status (or even sub-status) of each IP asset. The types of assets include but are not limited to: patents, copyrights, trade secrets, trademarks, trade names, and domain names. The subtypes for a United States patent for example include, but are not limited to, provisional and non-provisional patents, and utility, design, and plant patents. The status for a patent may include, but is not limited to, whether it is pending, allowed, issued, reissued, under reexamination, or abandoned. The trademark subtypes may include common law marks, state registered marks, and federally registered marks, and may be further broken down into trademarks, service marks, certification marks, collective marks, and membership marks. For trademarks, the status may include, but is not limited to, whether the mark is registered or pending. The substatus of a pending trademark may include whether the application is based on actual use or an intent-to-use. Copyright status may be registered or not registered. Copyright subtypes may include literary works, performing arts, sound recordings, visual arts, serials (newspapers, journals, magazines, and the like), architectural works, and multimedia works. Each type of asset may further be broken down by geographic region, such as the country or group of countries (such as the European Community, for example) in which the asset is registered, granted, pending, or the like. The classification step may further comprise organizing and listing each IP asset by its type.

Next in accordance with step 20, the documentation related to each IP asset is inspected. This inspection step may be performed simultaneously with or as a part of step 30, which comprises determining the validity of each IP asset.

This validation step may comprise verifying that the title or ownership of the asset is in the entity for which the audit is being performed, and may take into account the various authors, inventors, and/or assignees of the various assets, as well as any claims or ongoing litigation or disputes regarding ownership. Additionally, the validation step may comprise a patent or publication search for use in determining if, for example, the subject matter of a patent may have been disclosed in a prior publication or in use in a geographic region prior to a date which would bar the issuance of the patent. The validation step may include analyzing claims in the subject patent against overlapping claims in prior art patents to determine patentability or infringement. The validation step may further review the adequacy of the prior art search by the applicant and/or the patent office. For a copyright, the validation step may determine if the work is an original work, and may take into account plagiarism or substantial similarity to prior works without attribution. For trademarks, the validation step may include a search for prior rights held by others in marks that may arguably create a likelihood of confusion. For a trade secret, the validation step may include determining if the subject matter is properly protected as a trade secret, and if the entity has taken proper steps to safeguard the information as a trade secret. For a domain name, the validation step may determine whether the name violates anti-cybersquatting rules or otherwise may be subject to a dispute because of trademark rights of third parties. The validation step may also uncover potential third parties that are infringing the intellectual property asset, and may be used to generate projected financial data based on the cost of challenging the infringement and potential revenue to be gained from licensing revenue, settlements, or court awards.

Next, after each IP asset has been properly classified and validated, relevant financial data is identified and verified for each IP asset. The financial data may include the total net liabilities, taking into account expenses such as filing fees, issue fees, registration fees, maintenance fees or other annuities due, license fees, royalties owed, liens, encumberances, legal expenses, awards or settlements owed or paid, taxes, and any other expenses related to the asset. The financial data also includes the total net income, such as from royalties and licensing revenue, litigation or settlement awards, proceeds from sale of the assets, cash advances using the asset as collateral, and any other income attributable to the IP asset. The financial data may be apportioned according to the percentage of the asset owned or controlled.

The financial data may further include estimated net after tax income associated with the intellectual property status of the asset (revenue after subtraction of all manufacturing and overhead costs, after taxes). For example, if the asset enjoys a monopoly position due to its patent protection, all of the revenue generated by the product line associated with the asset may be attributable to the asset, because whomever owns the IP asset has the right to exclude all others from making the same product. On the other hand, if there is competition in the marketplace, and the patent protection is responsible for only a certain percentage of the market share of the product, only a portion of the net income may be actually attributable to the asset. The extent to which such data is included in the analysis may be a factor of the type of valuation being performed (see below) as well as a factor of how conservative an analysis is desired.

Once the type and status of the asset has been identified along with its corresponding financial data, the next step is to identify and verify a proper tangible valuation formula for each IP asset. The valuation formula may be largely dependent upon the status of the IP asset. For example, if the status is abandoned, lapsed, or expired, there may be little or no financial value remaining in the asset, and the value may be discounted accordingly to take into account its status. The number of years remaining until expiration of the IP asset, particularly for patents and copyrights, may therefore be a critical figure in the analysis. The valuation formula may also be industry or country dependent. For example, in a technology field such as computer technology, the projected value of the asset may likely be less toward the end of the patent term, because the rapid pace of technological advancement may be likely to render the patent obsolete before the end of its term. Assets in certain countries or geographic regions known for intellectual property piracy and poor enforcement may be valued less than the same type of asset in a country with a better historical enforcement track record.

The valuation formula may also be dependent upon the type of value being computed. For example, it may be desired to compute a net present value or an estimated future market value of the asset. The value may be a purchase or sale value, a donation, gift or charity value, a tax value, a book or cost value, or a collateral, loan, or license value. The formulae for calculating each value may differ, as is generally known in the art. Certain formulae may be developed specifically for taking into account the various factors and uncertainties inherent in intellectual property valuations. Various methods for intellectual property valuation have been documented in the art, and portions of any or all of such methods may be pertinent for use with the method of this invention.

Once the valuation formula has been chosen, a tangible valuation for each IP asset is computed and verified using the chosen formula, as shown in step 60. The verification portion of this step may include checking to make sure the correct formula has been chosen and that the correct data has been entered into the formula. A final check may be made to ascertain that the tangible value computed is meaningful and reasonable.

Step 65 comprises preparing an income statement reflecting the revenue and expenses associated with each IP asset. The reflected revenue and expenses may include licensing revenue and expenses, such as, without limitation, royalties and other miscellaneous payments associated with the IP asset, such as exclusivity fees, up front money and fees, bonus payments associated with the license, and the like. The reflected revenue and expenses may further include non-licensing revenues, such as, without limitation, operating revenue and expenses associated with business operations for activities such as producing, importing/exporting, marketing, distributing, or selling products directly related to the IP asset.

Next, in step 70, a balance sheet is prepared reflecting each intellectual property asset and its corresponding valuation. The balance sheet typically may list the number and type of IP assets, the ownership percentage in each, whether the title is owned or controlled by the entity being audited. The balance sheet may typically also reflect the validity of the asset and liabilities associated with the asset. Where there are uncertainties or unusual aspects worth noting, footnotes may be used to explain the basis for the statements made on the balance sheet, as is typically done in corporate financial statements. The balance sheet may show a net tangible asset value by classification of assets as well as a total net tangible IP asset value. Although the balance sheet may be a part of a corporate financial statement and may have a format similar to financial statements known in the art, the term “balance sheet” encompasses any essentially final product of this method that provides a listing of the intellectual property assets and their corresponding valuations. Although detailed balance sheets may be broken down by individual asset for internal evaluation, higher-level balance sheets reporting the results by groups of assets or by business divisions may be generated for public distribution.

Finally, in step 80, particularly where the audit is performed by an independent auditor, the auditor may issue an opinion certifying that the one or more intellectual property assets and corresponding tangible values are fairly stated in accordance with generally accepted accounting principles (GAAP). The methodology of this invention may ultimately be incorporated as part of the generally accepted principles. The auditor's opinion may merely be an informal opinion verbally communicated to the entity, or may be a written opinion, and for a corporate entity may take the form of the following:

### INTELLECTUAL PROPERTY AUDIT OPINION

To the Board of Directors and Stockholders of [CORPORATION]:

We have audited the accompanying Intellectual Property Asset financial statements of [CORPORATION], for the period ending [DATE]. We have conducted our audit in accordance with generally accepted accounting principles. We believe that our audit provides a reasonable basis for our opinion.

In our opinion, we believe the Intellectual Property financial statements present fairly, in all material respects, the tangible asset values, income and expenses of the Intellectual Property Assets of [CORPORATION] for the period ending [DATE] in conformity with generally accepted accounting principles.

The IP audit method of this invention can be performed on one or more of any type of IP asset, including but not limited to: patents, trade secrets, copyrights, trademarks, service marks, domain names. The assets may include, but are not limited to, articles of manufacture, such as physical products or intermediates; processes; business methods; software; databases; logos; literary, artistic, or architectural works; sound, video, or motion picture recordings; or any subject matter that can be protected by any of the categories of intellectual property under the laws of any country, state, or geographical or geopolitical region.

The IP audit method of this invention can be performed for any entity, including but not limited to corporations, limited liability companies, partnerships, sole proprietorships, governments, charities, trusts, endowments, universities, individuals, and the like. The IP audit method of this invention can be performed for valuation of IP assets for any purpose, including but not limited to establishing value basis, or for purchase, sale, license, litigation, donation, tax, and the like. The audit may be carried out internally within a business organization, or by a third party. When a third party conducts the audit, the third party may be engaged pursuant to an engagement letter. The auditor, upon beginning the audit, may first develop an IP asset audit checklist for making sure that each step covers every possible aspect of the entity's IP portfolio.

Preferably, the method is performed as a periodic and recurring audit that is recorded on the balance sheet of the entity's financial statements. The IP audit can be performed for any period, but is preferably done on a monthly, quarterly or annual basis. The audit can be performed by itself, but is preferably performed as part of the annual financial reporting process. The method can be performed to any degree of completeness with respect to the IP holdings of the entity, such as in accordance with a representative sampling, but preferably comprises a 100% audit of all IP assets with respect to all relevant data associated therewith. The IP opinion can be based upon any standard, but preferably upon generally accepted accounting principles (GAAP). The opinion can be qualified or unqualified.

The audit can be of any scope, and can cover any aspect of intellectual property, but preferably identifies and verifies financial data including but not limited to that discussed above. It should be understood that to the extent that specific examples of assets, financial data, and valuation purposes are described above, the method is by no means limited to these detailed examples. Those skilled in the art having the benefit of the teachings of the present invention as set forth herein above, can effect numerous modifications thereto. These modifications are to be construed as being encompassed within the scope of the present invention as set forth in the appended claims.

What is claimed:

1. A method for auditing one or more intellectual property assets of an entity, the method comprising:
(a) identifying and classifying each intellectual property asset;
(b) inspecting documentation related to each intellectual property asset;
(c) determining validity of each intellectual property asset;
(d) identifying and verifying relevant financial data for each intellectual property asset;
(e) identifying and verifying a proper tangible valuation formula for each intellectual property asset;
(f) computing and verifying a tangible valuation for each intellectual property asset using said formula;
(g) preparing an income statement reflecting revenue and expenses associated with each intellectual property asset;
(h) preparing a balance sheet reflecting each intellectual property asset and corresponding valuation; and
(i) issuing an opinion certifying that the one or more intellectual property assets and corresponding tangible values are fairly stated in accordance with generally accepted accounting principles.
